(19) United States
(12) Patent Application Publication
(10) Pub. No.: US 2017/0310140 A1
(43) Pub. Date: Oct. 26, 2017

(54) SYSTEM AND METHOD FOR REDUCING TIME-AVERAGED PEAK CHARGES

(71) Applicant: NEC Laboratories America, Inc., Princeton, NJ (US)

(72) Inventors: Babak Asghari, San Jose, CA (US); Ali Hooshmand, San Jose, CA (US); Ratnesh Sharma, Fremont, CA (US)

(21) Appl. No.: 15/498,034

(22) Filed: Apr. 26, 2017

Related U.S. Application Data
(60) Provisional application No. 62/327,482, filed on Apr. 26, 2016.

(51) Int. Cl. H02J 7/00; G05B 13/02

(52) U.S. Cl. CPC H02J 7/0068; G05B 13/021

(57) ABSTRACT

Systems and methods for minimizing demand charges, including determining one or more optimal monthly demand charge thresholds based on historical load data, time of use charges, demand charges, and energy storage unit size for one or more end users. A grid power dispatch setpoint is calculated for a particular time step based on a daily load forecast and a daily economic dispatch solution based on the determined optimal monthly demand charge thresholds. A grid power dispatch setpoint for a subsequent time step is determined by iteratively solving the daily energy dispatch for the subsequent time step to determine an optimal grid power dispatch setpoint. Energy and demand charges are minimized by controlling charging and discharging operations for the energy storage unit in real-time based on the determined optimal grid power dispatch setpoint.

### RELATED APPLICATION INFORMATION

This application claims priority to provisional application No. 62/327,482, filed on Apr. 26, 2016, incorporated herein by reference in its entirety.

### BACKGROUND

### Technical Field

The present invention relates generally to management of energy storage systems, and more particularly, to management of energy storage system operations to minimize peak demand charges.

### Description of the Related Art

Peak demand generally describes a period of simultaneous, strong consumer energy demand. Peak demand, (e.g., peak load) in terms of energy demand management describes a period in which electrical power is expected to be provided for a sustained period at a significantly higher than average supply level. Peak demand fluctuations may occur on daily, monthly, seasonal and yearly cycles. For an electric utility company, the actual point of peak demand may be a single 15-minutes, half-hour or hourly period which represents the highest point of customer consumption of electricity. At this time there may be, for example, a combination of office, domestic demand, and at some times of the year, the fall of darkness.

Many utility companies charge customers for energy based on their individual peak demand. The highest demand during each month, or even a single 15 to 30 minute period of highest use in the previous year, may be used to calculate such charges. In some instances, peak demand may exceed the maximum supply levels that the electrical power industry can generate, resulting in power outages and load shedding. This often occurs during heat waves when use of air conditioners and powered fans raises the rate of energy consumption significantly. During a shortage authorities may request the public to curtail their energy use and shift it to a non-peak period.

Conventional systems and methods have attempted to reduce peak charges by, for example, setting a fixed threshold for user load, and if the load goes above this threshold, discharging the energy storage system. Another conventional method which attempts to reduce peak charges is to charge and discharge the energy storage system based on a particular time of day. However, these conventional systems and methods do not adequately reduce peak demand charges because, for example, they are not capable of optimizing energy management to minimize peak charges for individual end users based on the personalized needs of the end users.

### SUMMARY

According to an aspect of the present principles, a method is provided for minimizing demand charges, including determining one or more optimal monthly demand charge thresholds based on historical load data, time of use charges, demand charges, and energy storage unit size for one or more end users. A grid power dispatch setpoint is calculated for a particular time step based on a daily load forecast and a daily economic dispatch solution based on the determined optimal monthly demand charge thresholds. A grid power dispatch setpoint for a subsequent time step is determined by iteratively solving the daily economic dispatch for the subsequent time step to determine an optimal grid power dispatch setpoint. Energy and demand charges are minimized by controlling charging and discharging operations for the energy storage unit in real-time based on the determined optimal grid power dispatch setpoint.

According to another aspect of the present principles, a system is provided for minimizing demand charges, including determining, using a processor coupled to a memory, one or more optimal monthly demand charge thresholds based on historical load data, time of use charges, demand charges, and energy storage unit size for one or more end users. A grid power dispatch setpoint is calculated for a particular time step based on a daily load forecast and a daily economic dispatch solution based on the determined optimal monthly demand charge thresholds. A grid power dispatch setpoint for a subsequent time step is determined by iteratively solving the daily energy dispatch for the subsequent time step at regular, predetermined time intervals to determine an optimal grid power dispatch setpoint. Energy and demand charges are minimized by controlling charging and discharging operations for the energy storage unit in real-time based on the determined optimal grid power dispatch setpoint.

According to another aspect of the present principles, a non-transitory computer readable medium is provided for minimizing demand charges, including determining one or more optimal monthly demand charge thresholds based on historical load data, time of use charges, demand charges, and energy storage unit size for one or more end users. A grid power dispatch setpoint is calculated for a particular time step based on a daily load forecast and a daily economic dispatch solution based on the determined optimal monthly demand charge thresholds. A grid power dispatch setpoint for a subsequent time step is determined by iteratively solving the daily energy dispatch for the subsequent time step at to determine an optimal grid power dispatch setpoint. Energy and demand charges are minimized by controlling charging and discharging operations for the energy storage unit in real-time based on the determined optimal grid power dispatch setpoint.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating an exemplary processing system to which the present principles may be applied, in accordance with the present principles;

FIG. 2 is a block/flow diagram illustrating a system/method for management of energy storage system operations to minimize peak demand charges, in accordance with the present principles;

FIG. 3 is a block/flow diagram illustrating a system/method for management of energy storage system operations to minimize demand charges, in accordance with the present principles;

FIG. 4 is a block/flow diagram illustrating a high level method for management of demand to minimize peak demand charges, in accordance with the present principles;

FIG. 5 is a block/flow diagram illustrating a system/method for determining optimal demand charge thresholds, in accordance with the present principles;

FIG. 6 is a graph illustrating an exemplary demand charge threshold, in accordance with the present principles;

FIG. 7 is a system/method for determining optimal grid dispatch setpoints, in accordance with the present principles; and

FIG. 8 is a block/flow diagram illustrating a system for management of energy storage system operations to minimize demand charges, in accordance with the present principles.

### DETAILED DESCRIPTION OF PREFERRED EMBODIMENTS

In accordance with the present principles, systems and methods are provided for management and control of energy storage systems using a generated optimal peak charge reduction amount for minimizing peak demand charges/costs according to various embodiments.

In a particularly useful embodiment, a system and method for scheduling an energy storage system charge/discharge in accordance with the present principles such that the peak demand charges for the customers are minimized. The present invention includes an energy storage system management solution which can be used by electricity consumers to reduce their electricity bill through reducing the peak charges. Peak charges are a large portion of total electricity bill (up to 50%) for many users. It is noted that the electricity bills for most Commercial and Industrial (C&I) businesses is comprised of two main parts, namely consumption charges and demand charges. An energy storage system can be used to reduce the peak charges, and the present principles may be employed to manage energy storage system charge and discharge in a manner to minimize the peak charges and maximizes the return on the investment for the users.

The system and method according to the present principles is adaptive to changes in user load profiles, and can determine the optimal amount of peak charge reduction based on energy storage system capacity, load profile, and demand charge rates in accordance with various embodiments. The present principles may be employed to control energy storage system charge/discharge operations to reduce the peak charges for end users (e.g., energy customers). Furthermore, the present principles may be employed to minimize electric bills based on, for example, consumption energy charges and peak demand charges using Behind the Meter (BTM) storage systems in accordance with the present principles. Thus, in accordance with various embodiments, the present invention advantageously enables end users to pay less for their peak demand charges without reducing actual energy consumption, details of which will be described in further detail herein below.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

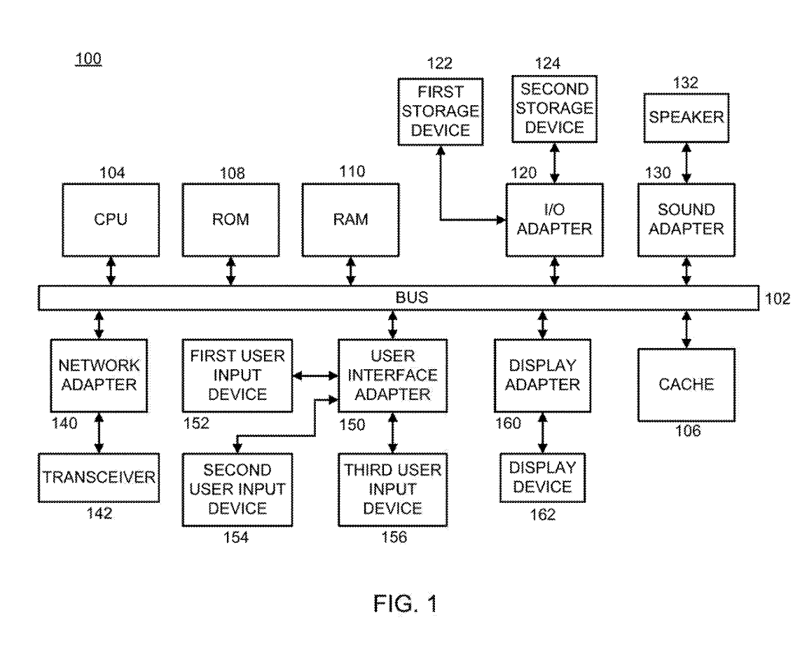

Referring now in detail to the figures in which like numerals represent the same or similar elements and initially to FIG. 1, an exemplary processing system 100, to which the present principles may be applied, is illustratively depicted in accordance with one embodiment of the present principles.

The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

Moreover, it is to be appreciated that systems 100, 200, 300, 500, 700, and 800, described with respect to FIGS. 1, 2, 3, 5, 7, and 8, respectively, are systems for implementing respective embodiments of the present principles. Part or all of processing system 100 may be implemented in one or more of the elements of systems 200, 300, 500, 700, and 800, according to various embodiments of the present principles.

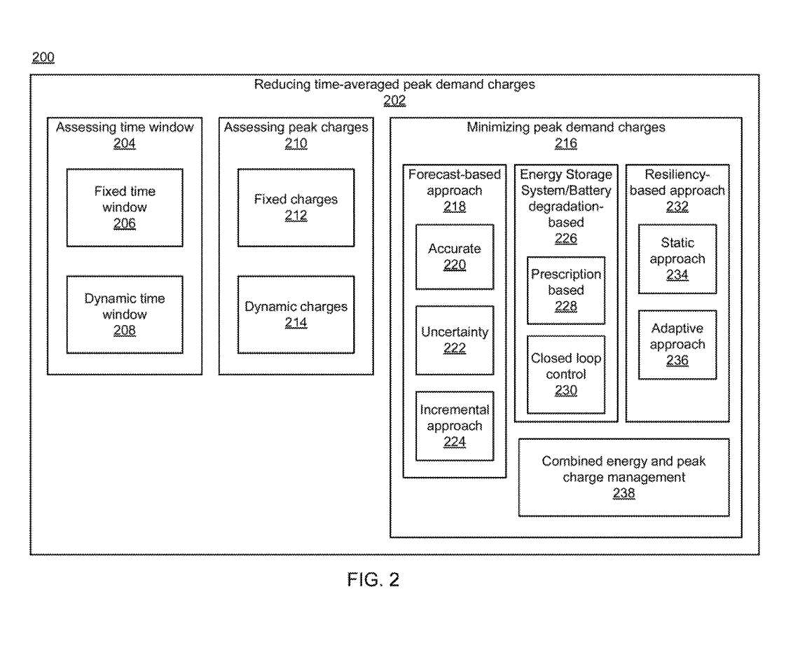

Further, it is to be appreciated that processing system 100 may perform at least part of the method described herein including, for example, at least part of methods 200, 300, 400, 500, and 700 of FIGS. 2, 3, 4, 5, and 7, respectively. Similarly, part or all of system 800 may be used to perform at least pan of methods 200, 300, 400, 500, and 700 of FIGS. 2, 3, 4, 5, and 7, respectively, according to various embodiments of the present principles.

Referring now to FIG. 2, a system/method 200 for management of energy storage system operations to minimize peak demand charges is illustratively depicted in accordance with an embodiment of the present principles.

In one embodiment, reduction (e.g., minimizing) of time-averaged peak demand charges may be performed in block 202 in accordance with the present principles. This minimizing may be managed by, for example, a controller (e.g., microcontroller) or computer/servers or cloud, and reduces the time-averaged peak charges for electricity consumers by, for example, coordinating charges and discharge of an energy storage system. In block 204, a time window over which the management system reduces the average peak charges for the users may be determined and/or specified. In one embodiment, the time window for average peak charge reduction may be a fixed time window 206, in which the time window for average peak charge reduction is fixed by the user or system operator. In another embodiment, the time window for average peak charge reduction may be a dynamic time window 206, in which the time window for average peak charge reduction is dynamic, and may be based on external factors (e.g., utility instruction, weather condition, season, etc.) in accordance with the present principles.

In block 210, peak charges may be assessed, and the manner to reduce the time averaged peak charges for the end users may be specified. In accordance with the present principles. In one embodiment, the charges may be fixed charges 212, and time-averaged peak charges may be reduced when such charges are fixed. In another embodiment, the charges may be dynamic charges 214, and time-averaged peak charges may be reduced when such charges are dynamic (e.g., continuously changing) in accordance with the present principles.

In block 216, peak demand charges may be minimized in accordance with various embodiments of the present principles. In one embodiment, a forecast-based approach 218 may be employed to minimize peak demand charges. This approach 218 may include forecasting the user load profile over a particular time window and solving an optimization problem to minimize the time-averaged peak charges by controlling charge and discharge of an energy storage system unit in accordance with the present principles. In one embodiment, this approach 218 may be referred to as accurate 220, in which a user load profile can be predicted with high accuracy and deterministic optimization methods can be used. In another embodiment, this approach 218 may be referred to as including uncertainty 222, in which a user load profile is uncertain and stochastic optimization methods can be used.

In block 224, instead of forecasting the load profile for the entire time window, the time window may be divided into increments using an incremental approach. In accordance with the present principles, load profiles may be forecasted for the current increment, and then an energy storage system charge/discharge operation may be optimized to minimize the peak charges in the current time window in accordance with various embodiments.

In one embodiment, an energy storage system degradation-based approach 226 may be employed to minimize peak charges. This approach 226 may include adjusting the energy storage system charge/discharge profile based on energy storage system degradation instead of user load profile. In block 228, a prescription-based approach may be employed in accordance with the present principles, in which the energy storage system charge/discharge profile may be adjusted to keep the energy storage system degradation rate in each time window below the prescribed energy storage system degradation. In block 230, a closed-loop control may be employed in accordance with the present principles, in which the energy storage system degradation may be measured at the end of each time window, and energy storage system charge/discharge profiles in the subsequent time window may be adjusted based on a current degradation value.

In another embodiment, a resiliency-based approach 232 may be employed to minimize peak demand charges. This approach 232 may include using part of the stored energy in the energy storage system as a margin for asset health, or as a backup. Then, the rest of the energy storage system capacity may be used for peak charge reduction in accordance with various embodiments of the present principles. In block 234, a static approach, in which the amount of stored energy in the energy storage system as a margin for asset health or as a backup is constant over time may be employed in accordance with one embodiment. In block 236, an adaptive reach approach may be employed, in which the amount of stored energy in the energy storage system as a margin for asset health or as a backup is changing over time based on forecasted parameters in accordance with the present principles. In one embodiment, combined energy and peak charge management may be performed in block 238, in which energy storage system charge/discharge profiles may be optimized to minimize electricity cost and time-averaged peak charges at the same time in accordance with the present principles.

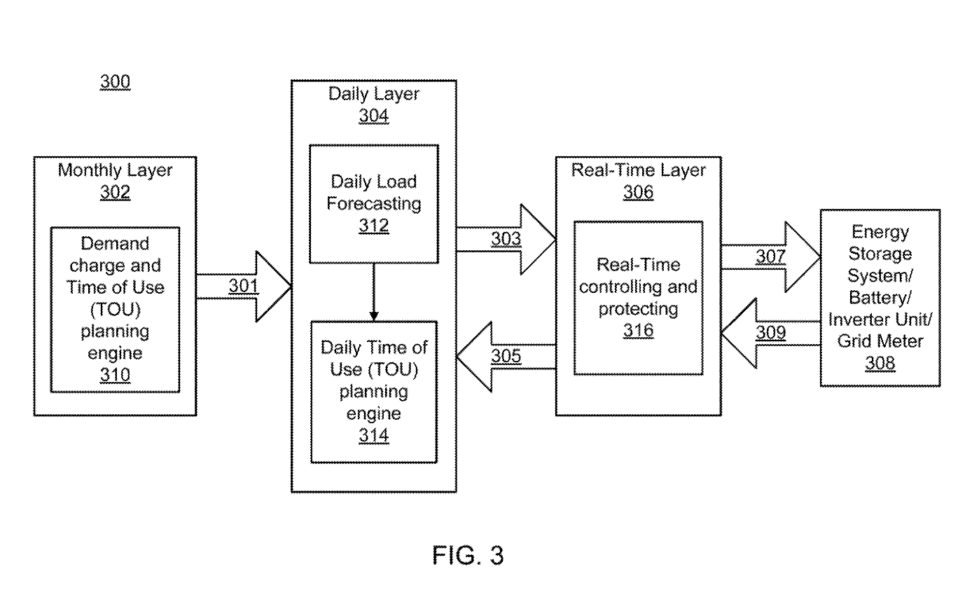

Referring now to FIG. 3, a system/method 300 for management of energy storage system operations to minimize demand charges is illustratively depicted in accordance with an embodiment of the present principles.

In one embodiment, a monthly layer 302 may be employed for minimizing demand charges in accordance with the present principles. In block 310, a demand charge and Time of Use (TOU) may be determined using a demand charge and TOU planning engine. Monthly demand charge levels 301 may be sent to a daily layer 304, and the daily layer 304 may be employed for daily load forecasting in block 312, and daily TOU planning may be performed using a daily TOU planning engine in block 314. In block 303, a determined dispatch setpoint may be sent to a real-time layer 306 for real-time controlling and protecting in block 316 in accordance with the present principles. In block 307, control signals may be sent to an energy storage system/inverter unit/grid meter 308, which may send measurements 309 to the real-time layer in block 306. In block 305, system states may be sent to the daily layer from the real-time layer 306 in accordance with various embodiments of the present principles.

In some embodiments, the real-time layer 306 includes a rule-based controller to control energy storage system charge/discharge in real-time based on advice from monthly and daily layers while improving the robustness of solution, and provides protection for energy storage system/inverter units in block 316. Input to the real-time layer 306 may include, for example, dispatch setpoints from the daily layer, demand Charge thresholds from the monthly layer, TOU rates, energy storage system ratings, and/or measured energy storage system state of charge (SoC) and load in accordance with various embodiments. Output from the real-time layer 306 may include issuing control commands to batteries/inverter units in accordance with the present principles. The real-time control and protection in block 316 may account for off-peak charging, flat-rate operation, reserve operation, etc. of batteries/inverter units in accordance with the present principles.

In accordance with various embodiments, a real-time layer 306 is a rule-based controller which provides several useful functionalities for the Behind the Meter (BTM) energy management system (EMS) in accordance with the present principles. Since dispatch setpoints from the daily layer are only updated at major time-steps (e.g., 15˜30 minutes), real-time layer 306 is executed at a much faster rate (e.g., one minute or faster) to ensure stability, safety, and optimality of the operation to the extent possible. During normal operation of the system, the real-time layer 306 is mainly responsible for passing dispatch setpoints from daily layer 714 to the energy storage system unit. However, the real-time layer 306 can override daily layer 714 setpoints based on certain rules if necessary. Also, the real-time layer 306 measures and passes the energy storage system SoC to daily layer 714 at every major time-step in accordance with various embodiments.

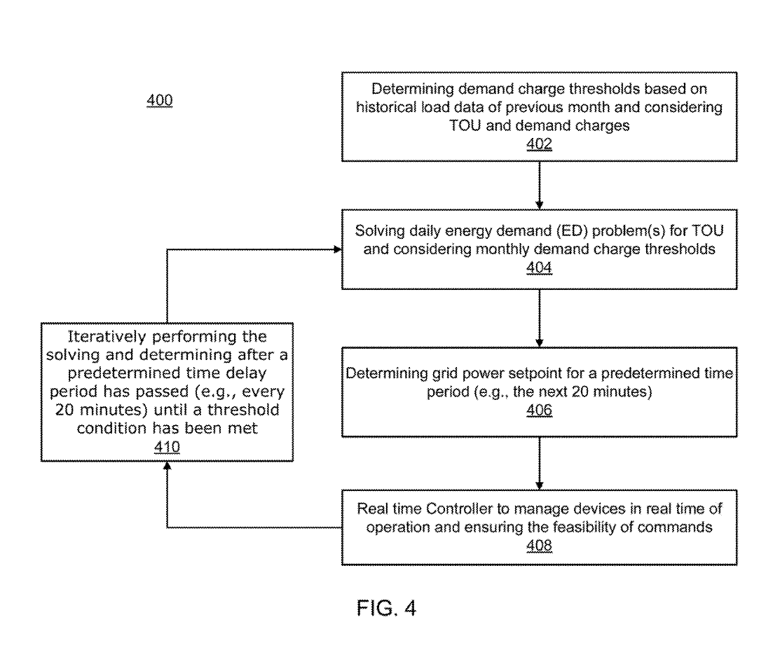

Referring now to FIG. 4, a high level method 400 for management of energy storage systems to minimize peak demand charges is illustratively depicted in accordance with the present principles.

In one embodiment, in block 402, demand charge thresholds may be determined based on historical load data of previous month, and considering TOU and demand charges. In block 404, daily energy demand (ED) problem(s) may be solved for TOU, and considering monthly demand charge thresholds. In block 406, a grid power setpoint may be determined for a predetermined time period (e.g., the next 20 minutes). In block 408, a real-time controller may be employed for management of devices in real time of operation, and to ensure the feasibility of various commands. In block 410, the solving in block 404 and the determining in block 406 may be iteratively performed after a predetermined time delay period has passed (e.g., every 20 minutes) until a threshold condition has been met in accordance with various embodiments of the present principles.

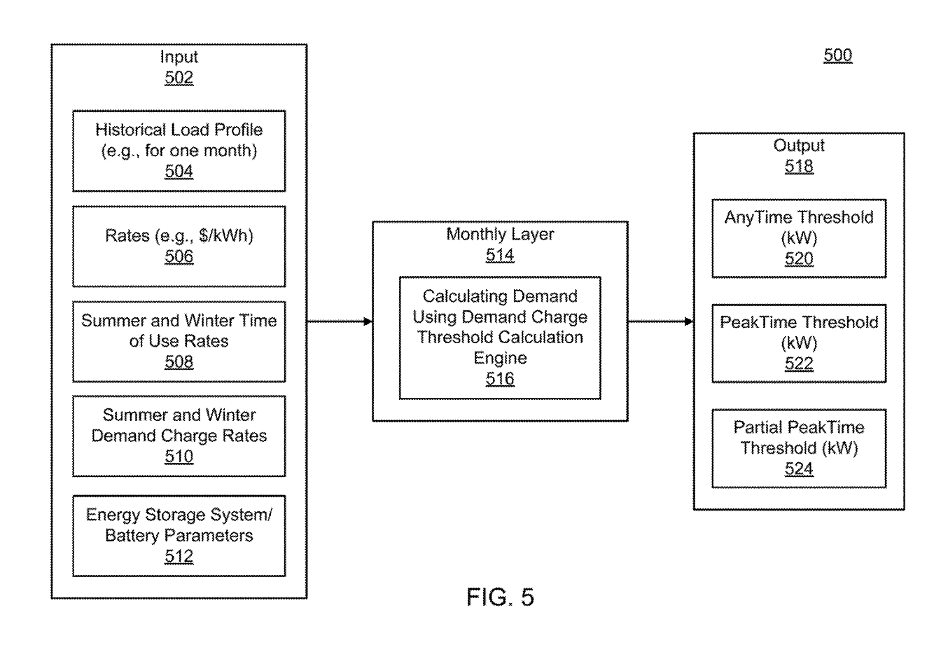

Referring now to FIG. 5, a system/method 500 for determining optimal demand charge thresholds is illustratively depicted in accordance with the present principles.

In an illustrative embodiment, in block 502, input may be entered into a monthly layer 214 of the system. The monthly layer 214 may include a planning/offline tool which may calculate optimal Demand Charge (DC) thresholds, using a DC threshold calculation engine in block 216, which may be employed by a particular customer during an entire month to minimize energy costs in accordance with the present principles.

The input in block 502 may include at least historical load profiles (e.g., for one particular month (e.g., data from a past month, data from a same month from the previous year, etc.) in accordance with various embodiments of the present principles. Other input may include, for example, demand charge and TOU rates in block 506, summer and winter TOU rates in block 508, summer and winter demand charge rates in block 510, and/or energy storage system parameters/ratings in block 512. The monthly layer 514 may then calculate an optimal demand charge threshold in block 516, details of which will be described in further detail herein below.

In accordance with various embodiments, the monthly layer 514 may provide output in block 518, which may include one constant demand charge threshold (in kW) for one or more off-peak periods at any particular time of a day in block 520 (e.g., AnyTime threshold), one constant demand charge threshold (in kW) for one or more peak periods in block 522 (e.g., PeakTime threshold), and/or one constant demand charge threshold (in kW) for one or more partial-peak periods in block 524 (e.g., Partial PeakTime threshold) in accordance with the present principles.

In some embodiments, the monthly layer 514 determines demand charge levels at the beginning of each month, as demand charges are based on maximum peak load within a month.

There are two main conditions which should be considered when calculating demand charge levels: (i) Repeatability: Energy storage system should be able to keep grid power below the demand charge levels every day during the month even during the worst case scenario; and (ii) Optimality: Demand charge levels may be calculated in a way to minimize total energy and demand charge costs at the end of each month. The present principles may include, for the monthly layer 214, taking one month of historical data and running an optimization in block 516 to minimize energy plus demand charge costs for every day of the month. Then by processing the results in accordance with the present principles, the highest demand charge levels during the month may be selected, and passed to the daily layer. In this way, it can be guaranteed that the grid power will always be below the optimal demand charge levels as long as the next month load is equal or less than the historical load.

In one embodiment, in block 516, for demand charge threshold calculation in the monthly layer 514 in case of uncertainty, an objective of a BTM Energy Management System (EMS) Monthly Layer (ML) 514 is to calculate an optimal Demand Charge Threshold (DCT) to be followed during the next billing cycle in accordance with the present principles. Optimal DCT is the DCT which minimizes the total electricity bill of a customer during each monthly billing cycle.

In most utilities, the actual DC is calculated based on maximum grid power over a month at different times of a day. Specifically, the DC structure that has been used for problem formulation in this report is composed of three main components:
i. Anytime DC: Defined as the maximum grid power over the entire time horizon.
ii. Partial DC: Defined as the maximum grid power only during the partial peak time periods of a day.
iii. Peak DC: Defined as the maximum grid power only during the peak time periods of a day.
   The final DC cost in an electricity bill is calculated by summing up all three components of the DC together. Thus the BTM EMS ML needs to calculate three optimal DCTs for anytime (DCT^{Anytime}), partial (DCT^{Partial}), and peak (DCT^{Peak}) times of the days accordingly.

Since daily demand profiles for the next month are not known, we need to use a forecasted demand profile. There are many different embodiments of the present principles which may synthesize a forecasted demand profile for the next month. In this report, historical demand from the past month (e.g., full month or part of the month) has been used as the forecasted profile for the next month. Each daily electricity cost is minimized individually. Thus the monthly optimization reduces to 31 (or any number of days in the month) daily optimization problems. The cost minimization problem in ML can be written as:

$$min J ∷ = {\sum }_{j = 1}^{24 \text{/} T} \{ {C}_{g} ( j ) \times {P}_{g} ( j ) \times T for everyday in a month + {C}_{DC}^{Anytime} \times max ( {P}_{g} ( j ) ) + {C}_{DC}^{Partial} \times max ( {P}_{g}^{Partial} ( j ) ) + {C}_{DC}^{Peak} \times max ( {P}_{g}^{peak} ( j ) ) \} + {C}_{b}^{throughout} \times ( {P}_{b}^{chg} ( j ) + {P}_{b}^{dischg} ( j ) ) \times T \times n \} \qquad ( 1 )$$

where J is the daily electricity bill for the month ahead. j is the optimization counter during each day starting from midnight (j=1) and ending at

$$j = \frac{24}{T}$$

j=where T is the optimization time-step in hour.

In an exemplary embodiment, if 15-minute optimization time-step is used in accordance with 15-minute time-step for DC cost calculation in utilities, then T is equal to 0.25 and j runs from 1 to 96 during cost minimization at the beginning of the day (4×24=96). C_{g}(j) and P_{g}(j) are the utility rate (in $/kWh) and grid power (in kW) during interval j respectively. C_{DC}^{Anytime}, C_{DC}^{Partial}, and C_{DC}^{Peak} are Anytime DC, Partial DC, and Peak DC (all in s/kW) respectively. P_{b}^{chg}, P_{b}^{dischg} are energy storage system charge power and energy storage system discharge power (in kW) respectively. C_{b}^{throughput} is energy storage system throughput cost in $ per kWh., where n is number of days in the month. P_{g}^{Partial}(j) is defined as:

$${P}_{g}^{Partial} ( j ) = \{ \begin{matrix}{P}_{g} ( j ) & if j ∈ partial peak time \\ 0 & otherwise\end{matrix} \qquad ( 2 )$$

Similarly, P_{g}^{peak}(j) can be defined as:

$${P}_{g}^{Peak} ( j ) = \{ \begin{matrix}{P}_{g} ( j ) & if j ∈ partial peak time \\ 0 & otherwise\end{matrix} \qquad ( 3 )$$

In some embodiments, in the monthly layer 514, DC only optimization can be carried out by removing the first term related to consumption charges from the objective function. Now that the objective function in the ML is defined, it is time to define the constraints in the optimization to complete the problem formulation. To alleviate the impact of forecasting errors on the performance of BTM EMS, we defined and used the concept of Reserved Capacity (RC) in BTM EMS. RC is a fixed portion of energy storage system energy which is excluded from any planning and optimization in monthly layer of BTM EMS. This capacity is only used in RTC if, at any time, assigned DCTs cannot be followed anymore because energy storage system has reached its minimum State of Charge (SoC) (excluding the RC) due to forecasting errors and cannot discharge to keep the demand below the DCT. It can be seen that RC acts as an energy buffer which is only used during extreme scenario and tries to minimize the impact of forecasting errors on the savings.

In accordance with various embodiments of the present principles, the first constraint related to upper and lower bounds on energy storage system SoC is defined as follows:

(SoC^{min}+SoC^{Reserve})≦SoC(j)≦SoC^{max} (4)

where SoC^{min}, SoC^{min}, and SoC^{Reserve} are lower and upper bounds and the Reserved Capacity in terms of SOC, respectively. SoC^{Reserve} is typically a constant number and an input by the system operator. Note that depending on the accuracy of forecasting methods, the amount of reserve could be more or less. In other words, more accurate forecasting methods require less reserve capacity in the system.
Next constraint is related to energy storage system maximum power as follows:

P_{b}^{chg}(j),P_{b}^{dischg}(j)≦p_{b}^{max} (5)

where P_{b}^{max} is energy storage system maximum energy storage system power.
The SoC equation of the energy storage system can then be written as:

SoC(j+1)=SoC(j)−αP_{b}^{dischg}(j)+αμP_{b}^{chg}(j) (6)

where α is a coefficient to convert kW to Ah, and μ is the roundtrip efficiency (between zero and one).

In some embodiments, the final constraint is related to Supply-Demand balance in the BTM system which is defined as:

P_{g}(j)+P_{b}^{dischg}(j)−P_{b}^{chg}(j)=P_{d}(j) (7)

Equations (1)-(7) describe a Linear Programming (LP) problem which can be solved by any LP solver. The solution to monthly problem (each day is solved separately) includes vectors of reference grid power (P*_{g}), reference energy storage system charge power (P*_{b}^{chg}), and reference energy storage system discharge power (P*_{b}^{dischg}) for every time step of optimization during every day for the entire month (or a subset of days in the month). For a 31-day month, the solution is as follows:

$$\begin{matrix} {\vec{P}}_{g}^{⋆} = [ {P}_{g}^{⋆} ( 1 , 1 ) ⋯ {P}_{g}^{⋆} ( 1 , \frac{24}{T} ) ⋯ {P}_{g}^{⋆} ( 31 , 1 ) ⋯ {P}_{g}^{⋆} ( 31 , \frac{24}{T} ) ] & ( 8 ) \\ {\vec{P}}_{b}^{⋆ chg} = [ {P}_{b}^{⋆ chg} ( 1 , 1 ) ⋯ {P}_{b}^{⋆ chg} ( 1 , \frac{24}{T} ) ⋯ {P}_{b}^{⋆ chg} ( 31 , 1 ) ⋯ {P}_{b}^{⋆ chg} ( 31 , \frac{24}{T} ) ] & ( 9 ) \\ {\vec{P}}_{b}^{⋆ dischg} = [ {P}_{b}^{⋆ dischg} ( 1 , 1 ) ⋯ {P}_{b}^{⋆ dischg} ( 1 , \frac{24}{T} ) ⋯ {P}_{b}^{⋆ dischg} ( 31 , 1 ) ⋯ {P}_{b}^{⋆ dischg} ( 31 , \frac{24}{T} ) ] & ( 10 )\end{matrix}$$

In accordance with the present principles, the LP solutions also include optimal DCTs for each day of operation in a given month. For the k-th day this can be written as follows:

$$\begin{matrix}{DCT}_{dayk}^{Anytime} = max ( {P}_{g}^{⋆} ( k , j ) ) j ∈ [ 1 , … , \frac{24}{T} ] & ( 11 ) \\ {DCT}_{dayk}^{Partial} = max ( {P}_{g}^{⋆} ( k , j ) ) j ∈ [ Partial Peak Period ] & ( 12 ) \\ {DCT}_{dayk}^{Peak} = max ( {P}_{g}^{⋆} ( k , j ) ) j ∈ [ Peak Period ] & ( 13 )\end{matrix}$$

In order to prepare the optimal DC thresholds for the month, we first remove the daily DC threshold outliers within the last 15 days of the month that are less than DCT^{Filter}. DCT^{Filter} is the norm of the vector, calculated as follows (for a 31-day month):

$${DCT}^{Filter} = \frac{\sqrt{{DCT}_{day 1}^{2} + … + {DCT}_{day 31}^{2}}}{31} \qquad ( 14 )$$

The set of selected thresholds within the last 15 days of the month, DCTs^{Selected}, are used to calculate the monthly threshold as follows:

DCT^{Monthly}=max(DCTs^{Selected})−α×[max(DCTs^{Selected})−min(DCTs^{Selected})] (15)

where α is the DCT Reduction ratio. Note that this process is repeated for any time, partial peak time, and peak time daily DC thresholds separately.

In one embodiment, in block 516, a demand charge threshold calculation in the monthly layer 514 may be performed in the case of accurate, in accordance with the present principles. In a perfect case, it may be assumed that monthly demand profile is exactly known in advance. This assumption results in two main changes in the ML calculations.

First we do not need to keep any reserve to handle uncertainties of the demand profile. Thus (4) changes to:

SoC^{min}≦SoC(j)≦SoC^{max} (16)

The above equation means that reserve capacity is equal to zero in perfect case.

Second, we solve the monthly optimization problem at once without decomposing it into individual days. Thus, the optimization objective function in perfect scenario can be written as

$$min J ∷ = {\sum }_{i = 1}^{31 \text{/} T} {\sum }_{j = 1}^{24 \text{/} T} \{ {C}_{g} ( i , j ) \times {P}_{g} ( i , j ) \times T + {C}_{DC}^{Anytime} \times max ( {P}_{g} ( i , j ) ) + {C}_{DC}^{Partial} \times max ( {P}_{g}^{Partial} ( i , j ) ) + {C}_{DC}^{Peak} \times max ( {P}_{g}^{peak} ( i , j ) ) \} + {C}_{b}^{throughout} \times ( {P}_{b}^{chg} ( j ) + {P}_{b}^{dischg} ( j ) ) \times T \} \qquad ( 17 )$$

In some embodiments, the above objective function is then minimized by considering problem constraints (5)-(7) and (16). Once monthly optimization is solved, DCTs are calculated as follows:

DCT_{Monthly}^{Anytime}=max(P_{g}(i,j)),

DCT_{Monthly}^{Partial}=max(P_{g}^{Partial}(i,j)),DCT_{Monthly}^{Peak}=max(P_{g}^{peak}(i,j)) (18)

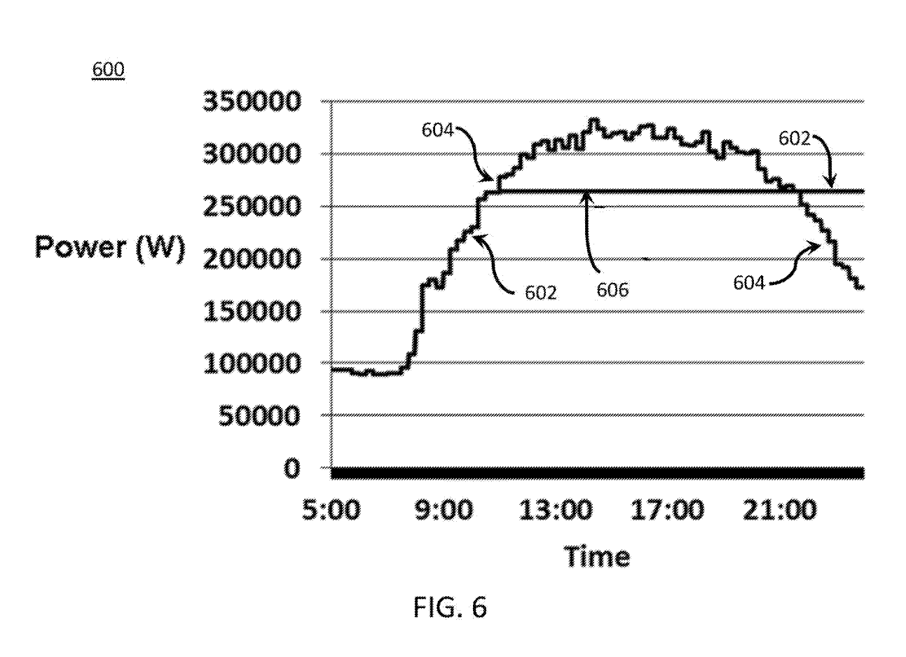

Referring now to FIG. 6, a graph 600 showing an exemplary demand charge threshold for a monthly layer is illustratively depicted in accordance with the present principles. In this exemplary embodiment, a demand charge threshold is represented by 606, grid power (W) is represented by 602, and demand (W) is represented by 604 over a particular time period.

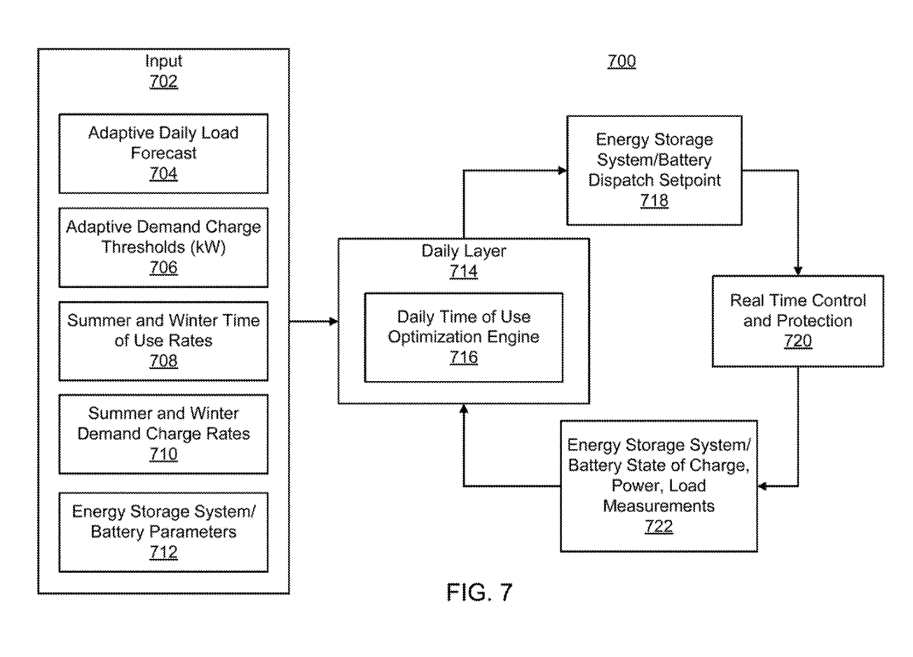

Referring now to FIG. 7, a system/method 700 for determining optimal grid dispatch setpoints, including real-time control and protection, is illustratively depicted in accordance with the present principles.

In one embodiment, a daily layer 714 may be employed, and the daily layer may include a daily TOU optimization engine 716. The daily layer 714 may include an operational engine 716, which calculates grid dispatch setpoints for a subsequent time step to minimize daily electricity costs while following the monthly demand charge thresholds in accordance with various embodiments of the present principles. The daily layer 714 calculations may be run at sub-hourly intervals (e.g., 20 minutes, 30 minutes, etc.).

In block 702, input may be entered into the daily layer 714. The input may include, for example, historical load profiles for a previous time interval (e.g., 3 days) in block 704, demand charge thresholds determined in the monthly layer in block 706, a measured energy storage system state of charge 722, summer and winter TOU rates in block 708, summer and winter demand charge rates in block 710, and/or energy storage system ratings/parameters in block 712. In some embodiments, other data related to expected load profiles in the next day (e.g., expected temperatures, occupancy, weekend, holidays, etc.) may be input for processing using the optimization engine in block 716 in accordance with the present principles. In block 718, determined grid dispatch setpoints 718 may be sent as input for real-time control and protection in block 720 in accordance with the present principles.

In the daily layer 714, the TOU electricity cost during each day of operation may be minimized while keeping the grid power below the DC thresholds obtained from the output of the monthly layer in accordance with the present principles. In some embodiments, the daily layer 714 may be closed-loop and adaptive. It may recalculate the grid dispatch setpoints 718 at regular time intervals (e.g., every 20 or 30 minutes) based on the new information about forecasted load profile, measured energy storage system state of charge and any changes in the demand charge thresholds.

In various embodiments, the daily layer 714 is used when the “combined energy and peak charge management” mode is active. The daily layer 714 in the Behind the Meter (BTM) management system and method in accordance with the present principles is responsible for continuous adjustment of energy storage system power (P_{b}^{dischg}, P_{b}^{chg}) and grid power (P_{g}) based on most recent information about the system to minimize the electricity cost during the operation. For this purpose, we used Model Predictive Control (MPC) to optimize each time step of operation while keeping future time steps in account. The daily layer 714 time step may be selected in the range of, for example, 15˜30 minutes in accordance with various embodiments.

At each daily layer 714 time step, a CC minimization problem for the rest of the day is solved. This implies that the optimization time horizon in daily layer 714 is dynamic and includes all time slots between current time during the day and end of the day. When solving CC minimization problem in daily layer 714, we keep track of DCTs and make sure that grid power is always equal or less than these thresholds.

For illustrative purposes, it may be assumed that we are at the N-th time step of operation during a day. The objective function for the daily layer 714 can be written as:

$$min F ∷ = {\sum }_{j = N}^{24 \text{/} T} {C}_{g} ( j ) \times {P}_{g} ( j ) \qquad ( 19 )$$

where F is total CC of the system between now and end of the day. T′ is the daily layer 714 time step. Note that T′ in daily layer 714 and T in ML do not need to be equal.

The minimization problem in daily layer 714 (19) is subjected to energy storage system SoC constraints (4), energy storage system power constraints (5), and supply-demand balance equality constraint (7). Furthermore, we include constraints related to DCTs from the monthly layer, as follows:

P_{g}(j)≦DCT^{Anytime} (20)

P_{g}^{Partial}(j)≦DCT^{Partial} (21)

P_{g}^{Peak}(j)≦DCT^{Peak} (22)

An original solution to LP problem in daily layer 714 is reference grid and energy storage system powers for each time-step during rest of the day, as follows:

$$\begin{matrix}{\vec{P}}_{g}^{⋆} = [ {P}_{g}^{⋆} ( N ) {⋯P}_{g}^{⋆} ( \frac{24}{{T}^{′}} ) ] & ( 23 ) \\ {\vec{P}}_{b}^{⋆ chg} = [ {P}_{b}^{⋆ chg} ( N ) {⋯P}_{b}^{⋆ chg} ( \frac{24}{{T}^{′}} ) ] & ( 24 ) \\ {\vec{P}}_{b}^{⋆ dischg} = [ {P}_{b}^{⋆ dischg} ( N ) {⋯P}_{b}^{⋆ dischg} ( \frac{24}{{T}^{′}} ) ] & ( 25 )\end{matrix}$$

However in some embodiments of the present principles, the BTM EMS only uses the current solutions at time step N (P*_{g}(N), P*_{b}^{chg}(N), P*_{b}^{dischg} (N)) for system operation in the subsequent, for example, 15˜30 minutes and passes them to the Real Time layer. Dispatch setpoints for future time steps are discarded because they are recalculated in the future. Note that at each time step, daily layer 714 also receives measured energy storage system SoC from the real-time layer to make sure correct initial SoC is used in daily layer 714 minimization problem.

As described above, an iterative nature of daily layer 714 based on MPC method in accordance with the present principles, which may be repeated every 15˜30 minutes allows to use most recent information in the optimization. For example, if there is a sudden change in energy storage system SoC, the daily layer 714 uses the new SoC value as the initial condition during the subsequent time step of optimization. Furthermore, this advantageously enables updating forecasted load profile at each time step of daily layer 714 in accordance with various embodiments of the present principles.

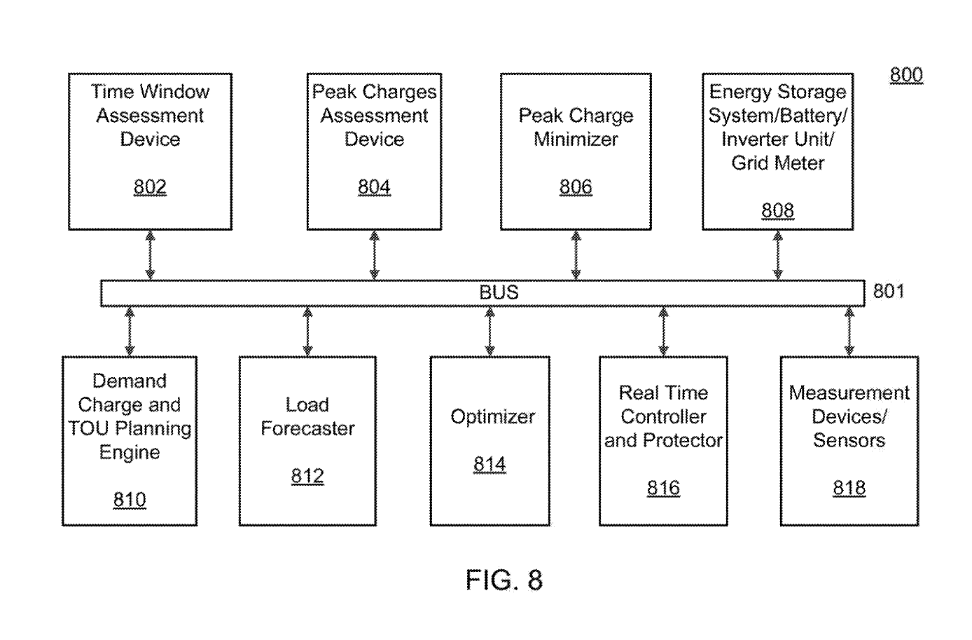

Referring now to FIG. 8, an exemplary system 800 management of energy storage system operations to minimize demand charges is illustratively depicted in accordance with the present principles.

While many aspects of system 800 are described in singular form for the sakes of illustration and clarity, the same can be applied to multiples ones of the items mentioned with respect to the description of system 800. For example, while a single energy storage system 808 is described, more than one energy storage system 808 can be used in accordance with the teachings of the present principles, while maintaining the spirit of the present principles. Moreover, it is appreciated that the energy storage system 808 is but one aspect involved with system 800 than can be extended to plural form while maintaining the spirit of the present principles.

The system 800 can include a bus 801, which may be connected to one or more computing networks, storage devices (not shown), and/or measurement devices and sensors 818 in accordance with various embodiments. In one embodiment, a time window assessment device 802 may be employed to determine/specify a time window over which the management system reduces the average peak charges for end users/customers. In block 804, a peak charges assessment device may be employed to assess peak demand charges, and to specify the manner to reduce the time averaged peak charges for the end users. A peak charge minimizer 806 may be employed to minimize peak charges for end users/customers in accordance with various embodiments of the present principles. An energy storage system/battery/inverter/grid meter 808 may be employed for energy storage, measurements, etc.

In various embodiments, a demand charge and TOU planning engine 810 may be employed in the monthly layer to determine demand charges, a load forecaster 812 may be employed to forecast daily loads. An optimizer 814 may be employed to optimize various portions of the system and method using, for example, a daily TOU planning engine in accordance with the present principles, and a real-time controller and protector 816 may be employed to control, for example, energy storage system charge/discharge operations in accordance with the present principles. Measurement devices 818 (e.g., sensors) may be deployed throughout one or more energy management/storage systems to, for example, obtain physical measurements of various portions of the energy management/storage systems for use as input to the system according to the present principles.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for minimizing demand charges, comprising:
determining one or more optimal monthly demand charge thresholds based on historical load data, time of use (TOU) charges, demand charges, and energy storage unit size for one or more end users;
calculating a grid power dispatch setpoint for a particular time step based on a daily load forecast and a daily economic dispatch (ED) solution based on the determined optimal monthly demand charge thresholds;
updating the grid power dispatch setpoint for a subsequent time step by iteratively solving the daily ED for the subsequent time step to determine an optimal grid power dispatch setpoint; and
minimizing energy and demand charges by controlling energy storage unit charging and discharging operations in real-time based on the determined optimal grid power dispatch setpoint.

2. The method as recited in claim 1, wherein the daily ED is an optimal daily ED determined based on at least one of updated forecasted load profiles, measured state of charge (SoC) of the energy storage unit, and changes in any demand charge thresholds.

3. The method as recited in claim 1, wherein the demand charges are time-averaged peak demand charges.

4. The method as recited in claim 3, further comprising reducing the time-averaged peak demand charges by controlling the energy storage unit charging and discharging operations based on incremental forecasting.

5. The method as recited in claim 4, wherein the incremental forecasting comprises:
dividing a selected time period into a plurality of time increments;
forecasting a load profile for a current time increment from the plurality of time increments; and
optimizing the energy storage unit charging and discharging operations for the current time increment based on the load profile forecast for the current time increment.

6. The method as recited in claim 1, wherein energy storage unit degradation is measured at an end of each of the time steps, and the energy storage unit charging and discharging operations for the subsequent time step are adjusted based on a current degradation value.

7. The method as recited in claim 1, wherein the energy storage unit charging and discharging operations are optimized to concurrently minimize overall energy charges and time-averaged peak demand charges.

8. The method as recited in claim 1, wherein a portion of stored energy in the energy storage unit is used as a margin for at least one of energy storage unit health or as a backup, and a remaining portion of the stored energy is used for peak demand charge reduction.

9. The method as recited in claim 8, wherein the portion of stored energy in the energy storage unit used as a margin is constant over a particular time period.

10. The method as recited in claim 8, wherein the portion of stored energy in the energy storage unit used as a margin varies over a particular time period based on forecasting.

11. A system for minimizing demand charges, comprising:
a processor coupled to a memory, the processor being configured to:
determine one or more optimal monthly demand charge thresholds based on historical load data, time of use (TOU) charges, demand charges, and energy storage unit size for one or more end users;
calculate a grid power dispatch setpoint for a particular time step based on a daily load forecast and a daily economic dispatch (ED) solution based on the determined optimal monthly demand charge thresholds;
update grid power dispatch setpoint for a subsequent time step by iteratively solving the daily ED for the subsequent time step to determine an optimal grid power dispatch setpoint; and
minimize energy and demand charges by controlling charging and discharging operations for the energy storage unit in real-time based on the determined optimal grid power dispatch setpoint.

12. The system as recited in claim 11, wherein the daily ED is an optimal daily ED determined based on at least one of updated forecasted load profiles, measured state of charge (SoC) of the energy storage unit, and changes in any demand charge thresholds.

13. The system as recited in claim 11, wherein the demand charges are time-averaged peak demand charges.

14. The system as recited in claim 13, wherein the processor is further configured to reduce the time-averaged peak demand charges by controlling the energy storage unit charging and discharging operations based on incremental forecasting.

15. The system as recited in claim 14, wherein the incremental forecasting comprises:
dividing a selected time period into a plurality of time increments;
forecasting a load profile for a current time increment from the plurality of time increments; and
optimizing the energy storage unit charging and discharging operations for the current time increment based on the load profile forecast for the current time increment.

16. The system as recited in claim 11, wherein energy storage unit degradation is measured at an end of each of the time steps, and the energy storage unit charging and discharging operations for the subsequent time step are adjusted based on a current degradation value.

17. The system as recited in claim 11, wherein the energy storage unit charging and discharging operations are optimized to concurrently minimize overall energy charges and time-averaged peak demand charges.

18. The system as recited in claim 11, wherein a portion of stored energy in the energy storage unit is used as a margin for at least one of energy storage unit health or as a backup, and a remaining portion of the stored energy is used for peak demand charge reduction.

19. The system as recited in claim 11, wherein the portion of stored energy in the energy storage unit used as a margin is constant over a particular time period.

20. A non-transitory computer readable storage medium comprising a computer readable program for minimizing demand charges, wherein the computer readable program when executed on a computer causes the computer to perform the steps of:
determining one or more optimal monthly demand charge thresholds based on historical load data, time of use (TOU) charges, demand charges, and energy storage unit size for one or more end users;
calculating a grid power dispatch setpoint for a particular time step based on a daily load forecast and a daily economic dispatch (ED) solution based on the determined optimal monthly demand charge thresholds;
updating the grid power dispatch setpoint for a subsequent time step by iteratively solving the daily ED for the subsequent time step to determine an optimal grid power dispatch setpoint; and
minimizing energy and demand charges by controlling energy storage unit charging and discharging operations in real-time based on the determined optimal grid power dispatch setpoint.
